(19) United States
(12) Patent Application Publication
(10) Pub. No.: US 2013/0191241 A1
(43) Pub. Date: Jul. 25, 2013

(54) SUBJECT MATTER INTELLIGENCE FOR BUSINESS APPLICATIONS

(71) Applicant: Steven M. Fillipi, Aurora, CO (US)

(72) Inventor: Steven M. Fillipi, Aurora, CO (US)

(73) Assignee: Oracle International Corporation, Redwood Shores, CA (US)

(21) Appl. No.: 13/356,397

(22) Filed: Jan. 23, 2012

(51) Int. Cl. G06Q 30/00

(52) U.S. Cl. 705/26.7

(57) ABSTRACT

Heuristics may be built into retail and business applications that recognize certain conditions and provide “expert-level” suggestions for the purchaser to consider. The inputs from the purchaser may include a selection of an item for potential purchasing. After selecting an item, heuristics may be used to determine that the item is also available as part of a set, which may include additional items that were meant to be used together, often at a discount. Also, heuristics may determine that a selected item has an expiration date, and make a recommendation for a same or functionally comparable product when near the expected end of the product's lifetime. Additionally, heuristics may be used to determine that a customer belongs to a certain customer type based on a selected item, and that customers of that type may be associated with additional items that may be offered to the consumer.

### BACKGROUND OF THE INVENTION

Advertising products is often the best, and sometimes the only way to inform potential customers and the advantages offered by various products. However, it is often difficult to discern the interest customers may have in additional products because of the limited time during which a retail or business salesperson has access to the customer. Often, any interaction is limited to the point of sale. For example a sales clerk may only have access to a customer while the customer is actually purchasing items at the point-of-sale. In these cases, very little information can be gleaned regarding a customer's interests in particular products other than those being purchased.

The problem of discerning additional products in which a customer might be interested is amplified when transactions take place in an online environment. E-commerce often exposes no other information to the retailer other than actual products being purchased. In some cases, retailers may make use of this information by suggesting other products that were purchased with a product selected by the consumer. For example, some online retailers suggests additional products by displaying a section entitled “Customer Who Bought This Item Also Bought” followed by a listing of additional products. Other online retailer use the search terms entered by the user, or meta-data tags linked to the products that a purchaser views to recommend additional products based on similarity to selected products.

### SUMMARY OF THE INVENTION

Various arrangements for providing subject matter intelligence for business applications are presented. A method for generating item recommendations may be presented. The method may include storing, by a computer system, information associated with a set of items, where the set of items may include a first item, at least the first item in the set of items may be available for sale individually, and each item in the set of items that is for sale individually may be associated with an item price. The set of items may be purchased as a single-purchase item, where the set of items may have a set price, and the set of items may have been packaged as a set by a manufacturer of the set of items. The method may also include receiving, by the computer system, a selection, and determining that the selection corresponds to the first item in the set of items. The method may further include determining, by the computer system, that the selection indicates an interest in the first item. The method may additionally include providing, by the computer system, an indication the that first item may be included in the set of items, and providing an indication that the set of items may be purchased as a single-purchase item at the set price.

Embodiments of such a method may include one or more of the following: The method may include providing, by the computer system, an indication of the item prices associated with each item in the set of items that is available for sale individually. The method may also include providing, by the computer system, a comparison between the set price and a sum of the item prices for each item in the set of items that is available for sale individually. The method may additionally include providing, by the computer system, an indication of a difference between the set price and a sum of the item prices for each item in the set of items that is available for sale individually. Furthermore, each item in the set of items may be functionally related to at least one other item in the set of items. The way in which each item may be functionally related to at least one other item in the set of items may be that each item in the set of items is for a recreational activity.

The method may also include storing, by the computer system, second information associated with a second set of items, where the second set of items includes the first item, the second set of items includes more items than the set of items, and the second set of items may be purchased as a single-purchase item. The second set of items may have a second set price. The method may further include providing, by the computer system, in response to the selection, an indication that the first item is also included in the second set of items, and providing an indication that the second set of items may be purchased as a single-purchase item at the set price. The method may additionally include receiving, by the computer system a second selection, and determining, by the computer system that the second selection corresponds to the set of items, and that the second selection indicates an interest in purchasing the set of items. Moreover, the method may include storing, by the computer system, in an electronic shopping cart, information associated with the selection which corresponds to the first item in the set of items, and determining that the first item may be removed from the electronic shopping cart based on the second selection. The method may also include removing, by the computer system, and in response to the second selection, the information associated with the selection from the electronic shopping cart, and possibly storing, by the computer system, in the electronic shopping cart; and in response to the second selection, information associated with the second selection which corresponds to the set of items.

A computer program product residing on a non-transitory processor-readable medium for providing subject matter intelligence for business applications may be presented. The computer program product may include computer-readable instructions configured to cause a computer to store information associated with a first item, where the first item may be available for sale, the first item may have an expected period of use, and the first item may be expected to be replaced approximately at an expiration of the expected period of use. The instructions may also be configured to cause the computer to receive a selection, where the selection indicates an interest in purchasing the first item, and the selection is made on a purchase date. The instructions may be further configured to cause the computer to determine a reminder date that may be based at least in part on the purchase date and the expected period of use, and provide an indication that may be associated with the reminder date that indicates the expiration of the expected period of use for the first item. Moreover, the instructions may be configured to cause the computer to provide information associated with a second item that may be substantially similar to the first item as a replacement for the first item.

Embodiments of such a product may include one or more of the following: After the expiration of the expected period of use, the first item may be expected to physically degrade. The second item may be the same type of item as the first item. The second item may be an alternate item that performs the same function as the first item. The indication that is associated with the reminder date may be provided prior to the reminder date. Providing an indication that is associated with the reminder date may occur in response to receiving an input from a user who purchased the first item, and/or on a date subsequent to the reminder date.

A system for generating item recommendations may be presented. The system may include a processor and a memory communicatively coupled with and readable by the processor and having stored therein processor-readable instructions which, when executed by the processor, cause the processor to store information associated with a customer type, where the information associated with the customer type may be comprised of a set of items, each item in the set of items may be associated with an interest of the customer type, and the set of items may include a first item. The instructions may further cause the processor to receive a selection, wherein the selection may indicate an interest in a second item, and may determine that the selection corresponds to the customer type at least in part by determining that the second item belongs to the set of items. The instructions may also cause the processor to provide, in response to the determination that the selection corresponds to the customer type, an indication that the first item may be purchased.

Embodiments of such a system may include one or more of the following: Determining that the selection corresponds to the customer type may be determined at least in part by information defining interests of a customer. The second item may be functionally related to the first item. Additionally, the instructions may cause the processor to store second information associated with a second customer type, where the second information associated with the second customer type may be comprised of a second set of items, each item in the second set of items may be associated with an interest of the second customer type, and the second set of items may include a third item. The instructions may also cause the processor to receive a second selection, wherein the second selection indicates an interest in the first item, and determine that the second selection corresponds to the second customer type at least in part by determining that the first item belongs to the second set of items. The instructions may further cause the processor to provide, in response to the determination that the second selection corresponds to the second customer type, an indication that the third item may be purchased.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates of block diagram of an embodiment of a system for generating item recommendations.

FIG. 2 illustrates an embodiment of an interface for receiving an item selection.

FIG. 3 illustrates an embodiment of an interface for providing an indication of recommended items.

FIG. 4A illustrates a flowchart of an embodiment of a method for recommending items associated with a set of items.

FIG. 4B illustrates a flowchart of another embodiment of a method for recommending items associated with a set of items.

FIG. 4C illustrates a flowchart of another embodiment of a method for recommending items associated with a set of items.

FIG. 5 illustrates an embodiment of an interface for providing an indication of recommended items.

FIG. 6 illustrates an embodiment of an interface for providing an indication of recommended items.

FIG. 7 illustrates a flowchart of an embodiment of a method for recommending items associated with an expected period of use.

FIG. 8 illustrates an embodiment of an interface for providing an indication of recommended items.

FIG. 9A illustrates a flowchart of an embodiment of a method for recommending items associated with a customer type.

FIG. 9B illustrates a flowchart of an another embodiment of a method for recommending items associated with a customer type.

FIG. 10 illustrates an embodiment of a computer system.

### DETAILED DESCRIPTION OF THE INVENTION

Heuristics may be built into retail and business applications that recognize certain conditions and provide “expert-level” suggestions for a customer to consider. Inputs from the purchaser may include a selection of an item for potential purchasing. After selecting an item, heuristics may be used to determine that the item is also available as part of a set, which may include additional items that were meant to be used together, often at a discount. Also, heuristics may determine that a selected item has an expiration date, and make a recommendation for a same or functionally comparable product near the expected end of the product's lifetime. Additionally, heuristics may be used to determine that a customer belongs to a certain customer type based on a selected item, and that customers of that type may be associated with additional items that may be offered to the consumer.

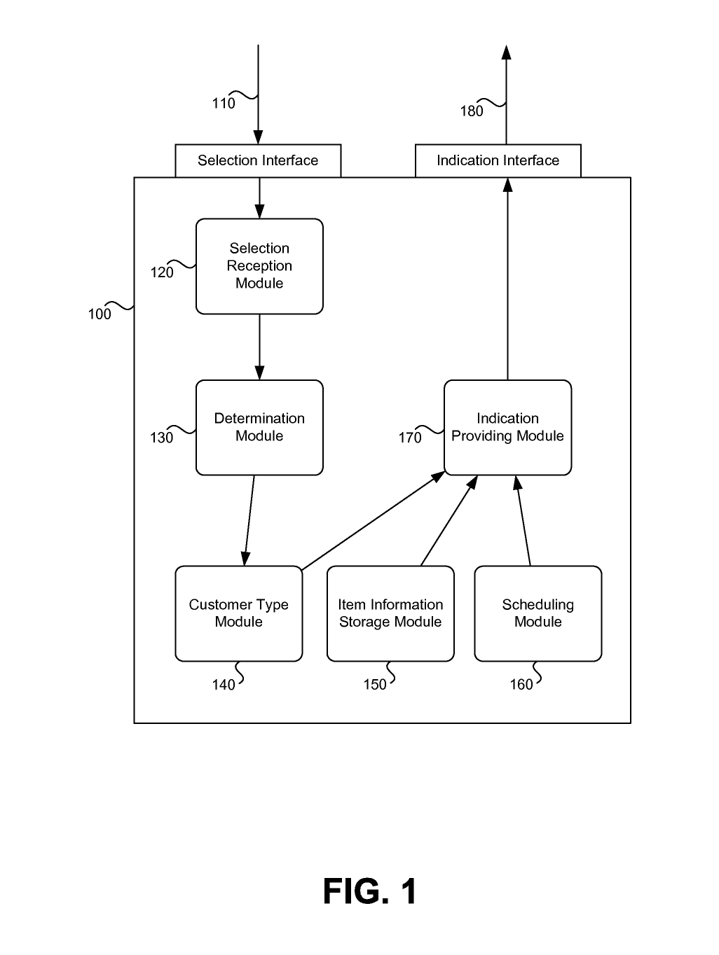

FIG. 1 illustrates an embodiment of a system for generating item recommendations. Recommendation system 100 may optionally include a selection reception module 120, a determination module 130, a customer type module 140, an item information storage module 150, a scheduling module 160, an indication providing module 170, a selection interface 110, and an indication interface 180. Although each of the separate modules and interfaces are displayed as individual components in FIG. 1, any and all of these modules may be combined in one or more software or hardware modules. For example the selection reception module 120 and the determination module 130 may be combined into a single software or hardware module. Furthermore, one or more of the modules in FIG. 1 may be split into separate software or hardware modules. For example, customer type module 140 may be split into two modules, one for managing customer types, and one for classifying customers into the various customer types.

Selection interface 110 may be comprised of any hardware or software combination that is configured to accept a selection of an item originating with a customer. For example, selection interface 110 may be a web interface, a bar code reader, a radio-frequency receiver, a point-of-sale device, an infrared receiver, and/or the like. Selection interface 110 may be used in conjunction with any manner of computer input device, such as a mouse, touch screen, touchpad, keyboard, voice recognition software, etc. In some embodiments, a customer may provide an item selection directly to selection interface 110, while in other embodiments, the customer may first provide an item selection to a second person, such as a sales associate, who may then provide the item selection to the selection interface 110.

Selection reception module 120 may be comprised of any hardware or software that is configured to receive a selection of an item from the selection interface 110. The selection reception module 120 may reside on a server, and may be associated with actions such as adding a selected item to an electronic shopping cart. Selection reception module 120 may optionally provide information associated with a selected item to determination module 130. Determination module 130 may be configured to make a determination as to additional items that may be recommended to the customer based at least in part on a selected item. Determination module 130 may interface with customer type module 140, with item information storage module 150, and/or with scheduling module 160. Determination module 130 may also provide information to the indication providing module directly.

Customer type module 140 may be configured to store customer profiles and provide information associated with customer profiles to other modules within the recommendation system 100. Additionally, customer type module 140 may manage customer types, which are associated with classes of customers grouped together based on a common characteristic, such as a common interest or demographic. Customer type module 140 may also classify customers into existing customer types, and/or create new customer types to accommodate new classes of customers.

Item information storage module 150 may be configured to manage information associated with individual items. Additionally, item information storage module 150 may be configured to store information that groups items together into sets of items. Set information may be provided to the determination module 130 to determine whether a selected item belongs to a set of items managed by the item information storage module 150.

Scheduling module 160 may be configured to manage the scheduling of events, such as indications that may be provided to customers. Indication providing module 170 may be configured to provide indications to customers associated with recommended items. Scheduling module 160 may work in conjunction with indication providing module 170 to provide indications to customers at an appropriate time based on various factors discussed further herein. Indication interface 180 may be configured to communicate item recommendations to a customer. Indication interface 180 may be implemented using any manner of hardware and/or software, including a computer system monitor, a touch screen, e-mail, text messaging, voice messaging, and/or the like.

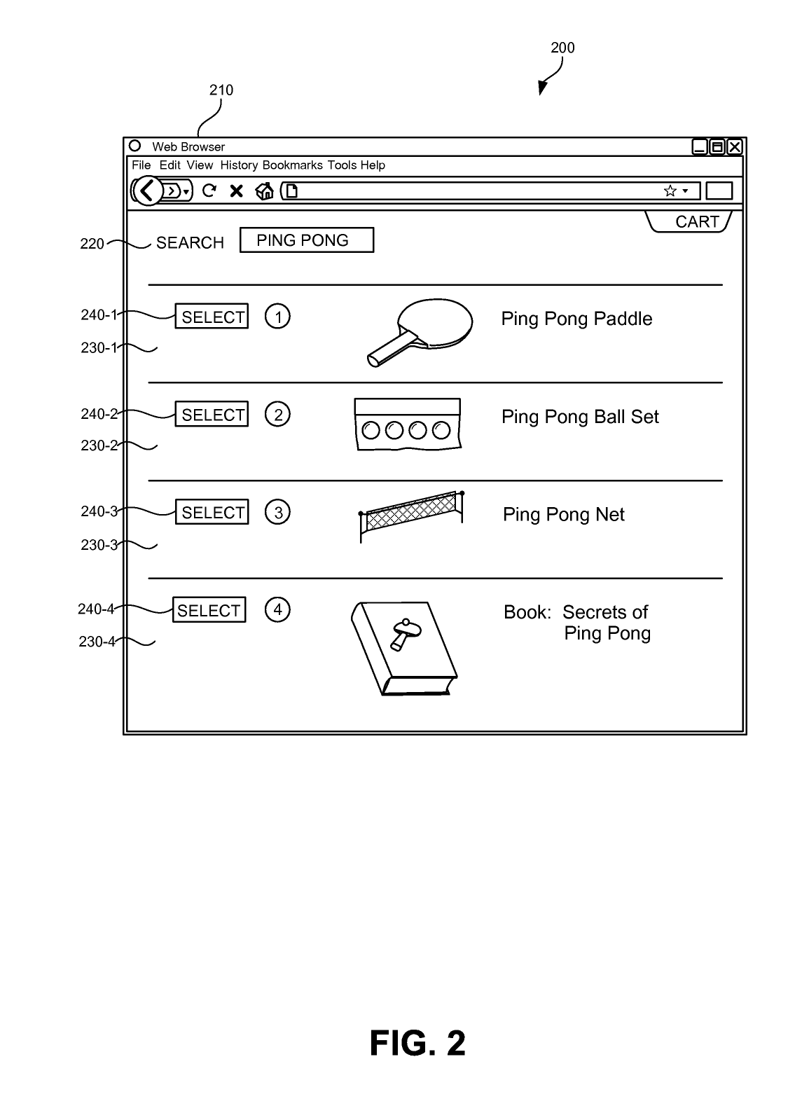

The recommendation system 100 may be operable from a single computer system, or it may be distributed among various hardware and software components that are not co-located. In one embodiment, the recommendation system resides on a server-client system, and an interface may be provided wherein a customer may access the recommendation system 100 remotely from a client workstation. As an example, FIG. 2 illustrates an interface 200 for selecting an item according to one embodiment. This particular embodiment illustrates a selection interface 110 comprising a browser window 210. Browser window 210 may include a search interface 220 for a customer to enter a text string to search for a particular type of item. For example, in FIG. 2 the customer has entered a search for the text string “ping-pong.” In response to entering the search string, the browser window 210 may display a list of items 230 that relate to the search term entered into search interface 220.

Items 230 that are displayed in response to the search term may be retrieved from the item information storage module 150. A display for each item 230 may include a description, a price, a graphic representation, a search ranking, and/or the like. The display for each item 230 may additionally include an interface configured to accept the selection of each item. For example, browser window 210 may include select buttons 240 for each of the items 230. The user may select the first item in the list, item 230-1 by clicking select button 240-1. By clicking select button 240-1, a user may be indicating that the user intends to purchase the selected item 230-1. Alternatively, in some embodiments, clicking the select button 240-1 may simply indicate that the user wishes to obtain more information associated with the selected item 230-1.

Although FIG. 2 illustrates an embodiment using browser window 210, other embodiments may use many different types of interfaces that are configured to accept the selection of an item. For example, one embodiment may comprise an interface to a database. Another embodiment may include a barcode reader coupled to a point-of-sale device. Yet another embodiment may operate in the absence of a human operator, wherein the selection interface 110 may accept the selection of an item from another automated system consisting of hardware and/or software. Therefore, it will be understood in light of this disclosure that many different types of methods and/or systems may be used as selection interface 110 to select an item.

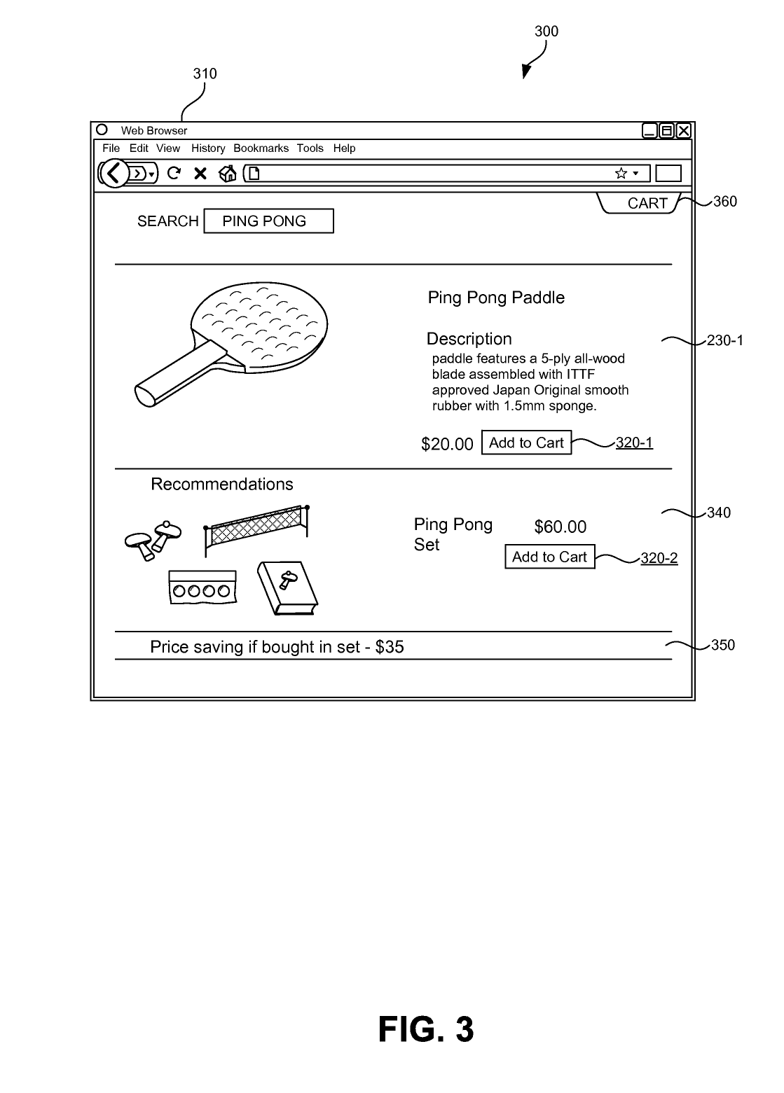

In one embodiment, the selection of a particular item from a list of items may invoke another interface configured to provide more information associated with the selected item, along with recommendations of other items. For example, user may click select button 240-1, indicating either an intent to purchase item 230-1, or any intent to display more information associated with item 230-1. In response, FIG. 3 illustrates an interface 300 for displaying a selected item for displaying recommendations of additional items according to one embodiment. In this embodiment, a customer may have selected the ping-pong paddle from browser window 210 in FIG. 2. This action may invoke browser window 310 to display additional information regarding the ping-pong paddle represented by item 230-1 along with additional recommended items 340.

Recommended items 340 may be displayed in a manner configured to link the recommended items 340 to the selected item 230-1. Browser window 310 may also include purchase buttons 320. Purchase buttons 320 may be configured to accept an input expressing an intent to purchase the item 230-1 and/or item 340. In response to clicking purchase buttons 320 the corresponding item may be placed in an electronic shopping cart available via cart button 360. Thus, the user may select an item from a list of items, the item may be displayed with other recommended items, and the user may choose to add one or more of the items and/or recommended items to the user's electronic shopping cart.

Again, the embodiment illustrated by FIG. 3 uses a web interface with an electronic shopping cart. However, other embodiments may use different methods to selected item 230-1 and to provide an indication of recommended items 340. For example, indication interface 180 may be configured to display a selection and/or recommended items to a sales associate or other third-party who may then communicate the recommended items to the customer. In another embodiment, indication interface 180 may utilize e-mail or other form of delayed communication to send a message to a user including information associated with recommended items. The user may then respond to the message at a time subsequent to providing the selection of the item upon which the recommendation was based. In yet another embodiment, a selected item may cause marketing materials containing information related to the recommended items to be sent to the customer. Other embodiments use various other methods of providing an indication of recommended items to customers that comprise varying amounts of time between the selection of the item and the providing of the indication of recommended items.

The embodiment in FIG. 3 may use a method of determining recommended items based on the item's membership in a set of items. In particular, recommended items 340 is comprised of a ping-pong set which includes the ping-pong paddle that was originally selected by the user. This embodiment may determine that a user is interested in an item that is both sold individually and packaged as a set with other related items. The set of items may be packaged as a set by the manufacturer of the items, by retailer, by a wholesaler, by an operator of a website, by a product aggregator, and/or the like. In some cases, additional items in the set of items may also be available for individual sale. However, when packaged as a set, all of the items may be available as a single purchase item, and in some cases may have a set price that is less than or equal to the sum of the items that are available for individual sale within set.

Because these items may be available as a set, a customer who is interested in a single item may also be interested in the additional savings and convenience that may be available by purchasing the additional items as a set. For example, it may be determined that a customer who is interested in a ping-pong paddle may also be interested in the additional supplies needed to play a game of ping pong, such as ping-pong balls, a ping-pong table, an additional ping-pong paddle, a ping-pong net, and/or rules of the game. The ping-pong balls, the ping-pong table, and the additional paddle may be available for individual sale. However, the ping-pong net and the rules of the game may only be available as part of a set.

Because some items may not be sold individually, it may be useful to provide an indication of other related items, such as the rules of the game, that are essential for using the selected item, such as the ping-pong paddle, which may only be available if purchasing the set. Additionally it may be useful to provide indications for customers that although other related items may be available for individual sale, the cost of purchasing these items individually may exceed the cost of purchasing these items as a set. In the embodiment of FIG. 3, the browser window 310 includes an indication 350 of the advantages of purchasing the items as a set. For instance, the indication 350 may display the money saved by purchasing the items as a set as opposed to purchasing the items individually. Alternatively or additionally, the indication 350 may display a notice that some items in the set are not available for individual sale, thus alerting the customer that the selected item may not be fully usable unless purchased in the set.

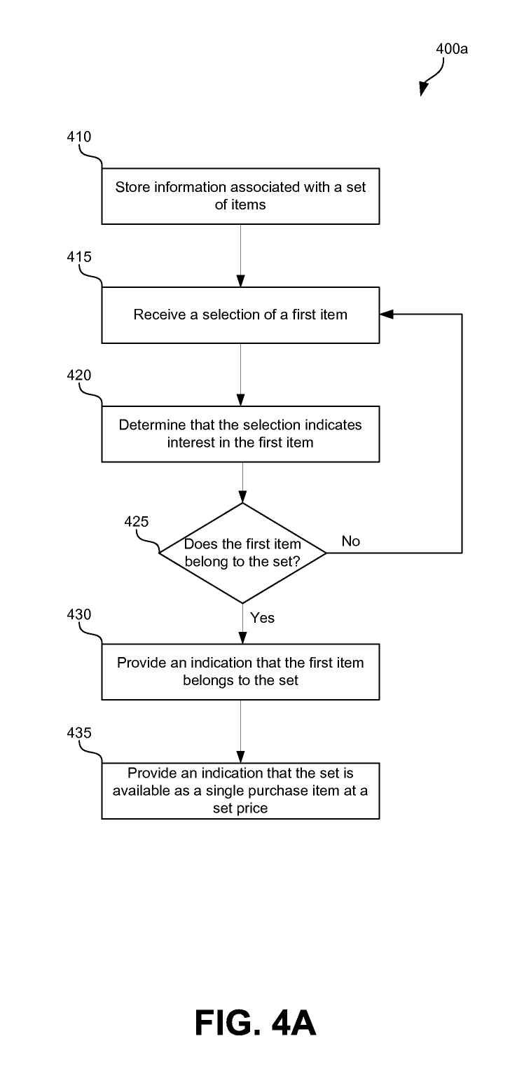

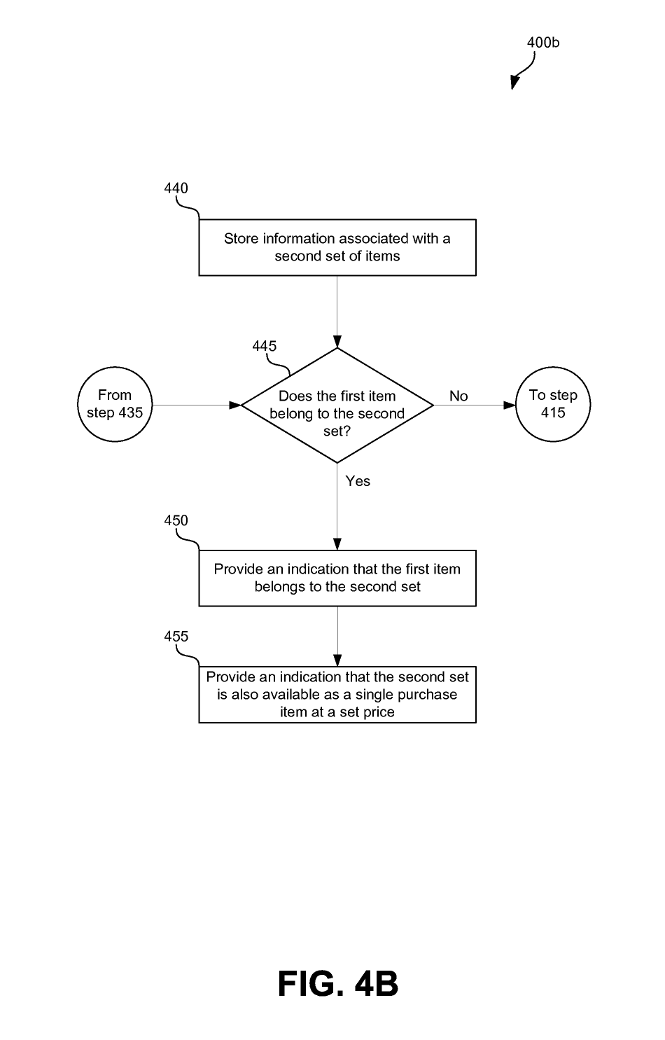

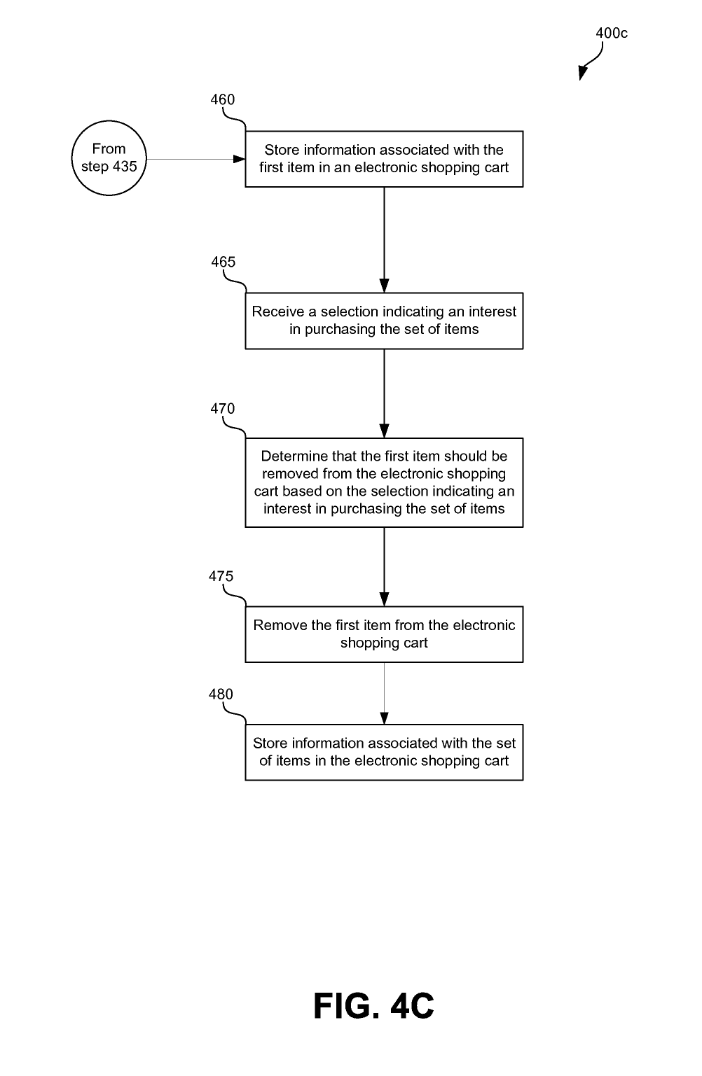

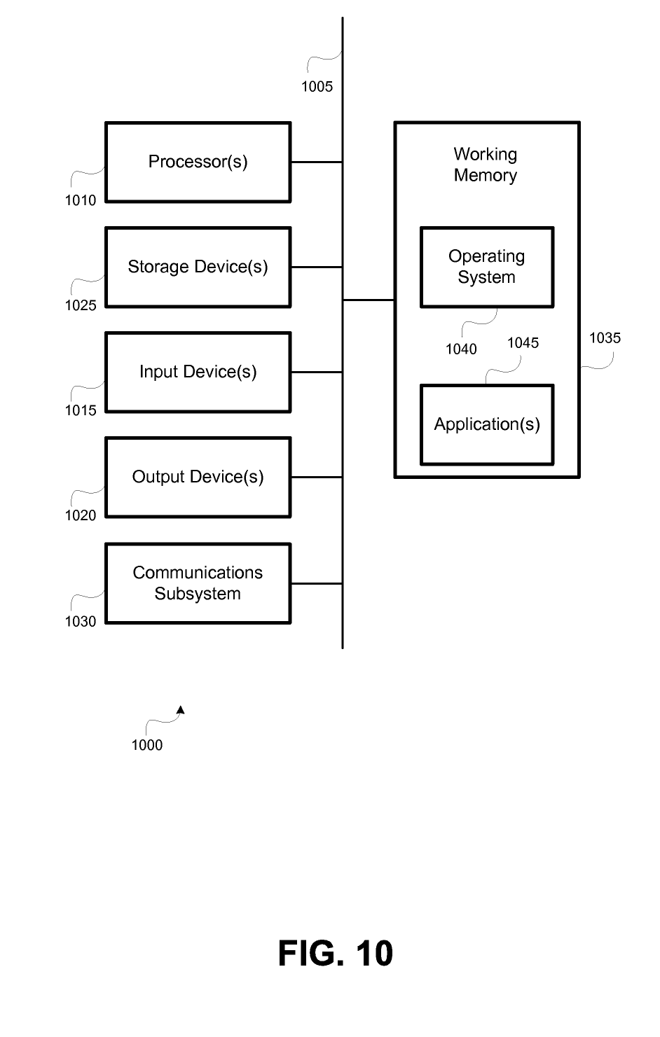

FIG. 4A illustrates a method 400a for recommending items associated with a set of items. Method 400a may use an interface similar to browser window 210 and browser window 310 in FIG. 2 and FIG. 3 respectively. Each step of method 400a may be performed using a computer system, such as the computer system 1000 of FIG. 10. This method may also be performed using the system detailed hereinabove.

At step 410, information associated with a set of items may be stored. This information may be stored in any of the memory elements of the computer system 1000 of FIG. 10, and may be performed by the item information storage module 150 of FIG. 1. In one embodiment, information regarding each item in the set of items may be co-located inside the memory. In another embodiment, information associated with each item in the set of items may be stored individually within one or more memories, and links to the separate memory locations are used to store the set relationship.

At step 415, the selection of a first item is received. The selection may be received through the selection interface 110 by the selection reception module 120. At step 420, a determination may be made as to the customer's intent regarding the selection. The selection of the first item may indicate that the customer is interested in purchasing the first item. Alternatively, the selection may indicate that the customer is interested in having more information associated with the first item displayed. In either case (desiring more information or desiring to purchase) may indicate sufficient interest in the first item for step 415.

At decision block 425, a determination may be made as to whether the first item belongs to the set of items. For example, selecting the ping-pong paddle in FIG. 2 may trigger a determination as to whether the ping-pong paddle belongs to the ping pong set in FIG. 3. If it is determined that the first item does not belong to the set of items, then the method 400a may return to step 415 to await the selection of another item. If it is determined that the first item does belong to a set of items, then step 430 may provide an indication that the first item belongs to the set of items. At step 435, an indication that the set is available as a single purchase item at a set price may also be provided. This indication may also be comprised of price comparison information. For example, the method 400a may provide a comparison between a set price and the sum of the prices of the items in the set that are available for sale individually. Additionally, the method 400a may provide an indication that certain items available in the set of items are not available for sale individually. This may include notifications and/or explanations as to why items in the set may be required in order to use the first item.

FIG. 4B illustrates a method 400b for recommending items associated with a second set of items. At step 440, information associated with a second set of items may be stored. As with the first set of items, this information may be stored in any of the memory elements of the computer system 1000 of FIG. 10, and may be performed by the item information storage module 150 of FIG. 1. The information associated with the second set of items may be stored in the same memory of the first set of items, or it may be stored in a different memory. For example, the first set of items to be stored in memory and/or accessible through system of a first retailer, in the second set of items may be stored in a memory and/or accessible through a system of a second retailer. Thus, the method 400b may compare sets of items available from different sources.

At decision block 445, a determination may be made as to whether the first item belongs to the second set of items. For example, if the ping-pong paddle in FIG. 2 is selected, a determination may be made as to whether a ping-pong paddle belongs to the ping-pong set in FIG. 3, and determination to be made as to whether the ping-pong paddle belongs to a second ping-pong set available from the same source or from a different source (not shown). If the first item does not belong to the second set of items, then the method 400b may return to step 415 of method 400a to await the selection of another item. If it is determined that the first item does belong to the second set of items, then step 450 may provide an indication that the first item belongs to the second set of items. At step 435, an indication that the second set is also available as a single purchase item at a set price may also be provided. This indication may be comprised of additional price comparison information. For example, the method 400b may provide a comparison between the second set price and the sum of the prices of the items in the set that are available for sale individually. Additionally, the method 400a may provide an indication that certain items available in the second set of items are not available in the first set of items. This may include notifications and/or explanations as to why items in the second set may be absent from the first set of items.

FIG. 4C illustrates a method 400c for adding a set of items to an electronic shopping cart. Following step 435 from FIG. 4A, information associated with the first item may be stored in an electronic shopping cart at step 460. In one embodiment, storing information in an electronic shopping cart may occur in response to receiving an input from purchase buttons 320 in browser window 310 of FIG. 3. In another embodiment, items may be added to an electronic shopping cart by scanning an electronic barcode associated with the item.

At step 465, a selection may be received which indicates an interest in purchasing a set of items. For example, a customer may add the ping-pong paddle to the customer's electronic shopping cart by clicking purchase button 320-1. After examining the recommended item 340, the customer may decide instead to purchase the ping-pong set by clicking on purchase button 320-2. Instead of requiring the customer to manually remove the ping-pong paddle from electronic shopping cart, it may be determined that the first item should be removed from the electronic shopping cart based on the selection of the set of items at step 470. For example, in one embodiment a computer system may automatically determine that because the first item is included in the set of items, it would be unlikely that a customer would want both the first item and the set of items in the electronic shopping cart. Thus, in the embodiment of FIG. 3, it may be automatically determined that a customer would be unlikely to want both the ping-pong paddle and the ping-pong set in electronic shopping cart.

At step 475, the first item may be removed from electronic shopping cart in response to the determination of step 470. In one embodiment, the first item may be removed automatically by a computer system. In another embodiment, the method 400c may provide an indication that the first item will be duplicated by the set of items, and that the first item may be removed from the electronic shopping cart. At step 480, information associated with the set of items may be stored in the electronic shopping cart. Thus, adding a set of items to the electronic shopping cart may result in the automatic removal of the first item. It will be understood in light of this disclosure that the steps of method 400c may be carried out in any order. For example, a set of items may be stored in the electronic shopping cart before, after, or at the same time that the first item is removed. Also, both the first item in the set of items may reside together in the electronic shopping cart for a duration of time.

The description hereinabove has mainly discussed the selection of a single item and the determination that the single item is a member of a set of items. However, other embodiments may be configured to make recommendations based on multiple selected items. If more than one selected item is available in the same set, the set of items may be recommended with additional emphasis. For example, if a user selected both a ping-pong paddle and a ping-pong ball, the ping-pong set may be recommended with more emphasis than if only one of the two item had been selected. A modal banner or window may be configured to be displayed by a computer system such that a customer may have to provide an input declining the purchase of the items as a single purchase in the set. In another embodiment, the multiple selected items may be available in different sets of items, resulting in multiple sets of items being recommended, where each set is of a different type. For example, a customer may select a ping-pong paddle and a book. As a result, both a ping-pong set and a set of books that include the selected book may be recommended to the customer.

Additionally, some embodiments may automatically determine when one or more selected items in an electronic shopping cart should be replaced. Instead of requiring customer input, a computer system may automatically determine that the selections should be replaced by the set of items after a threshold number of items in the set are selected. For example, in one embodiment, adding two items, such as a ping-pong paddle and a box of ping-pong balls, may be sufficient to automatically replace these two items with a ping-pong set. In another embodiment, when every item that is available for individual sale and available in a set has been selected, they may be replaced by the set of items. The automatic replacement of items with a set of items may also include providing a notification to the customer that the replacement occurred, with an option to undo the replacement.

In addition to recommending items based on their membership in a set of items, embodiments disclosed herein may recommend additional items based on expected period of use of a purchased item. Many items purchased by customers may have a physical lifetime after which the usefulness of the item may decrease or after which the item may become less safe. For example a package of disposable razors containing five razors may have an expected lifetime of one month. Therefore, one month from the purchase date, it may be expected that the razors would be used, and that the customer would need to purchase a replacement package of razors. As another example, purchasing milk or other perishable items may be associated with an expiration date. Regardless of the date of purchase, the customer may need to replace the perishable items after the expiration date because the items would either be consumed or expired. In yet another example, items such as software may include a license with an expiration date. Although the software may not physically degrade like a consumable item or a perishable item, it may become unusable after the expiration date of the license. In each of these cases, and in similar situations not enumerated here, a customer may benefit from an indication that an item they purchased may no longer be usable and should be replaced.

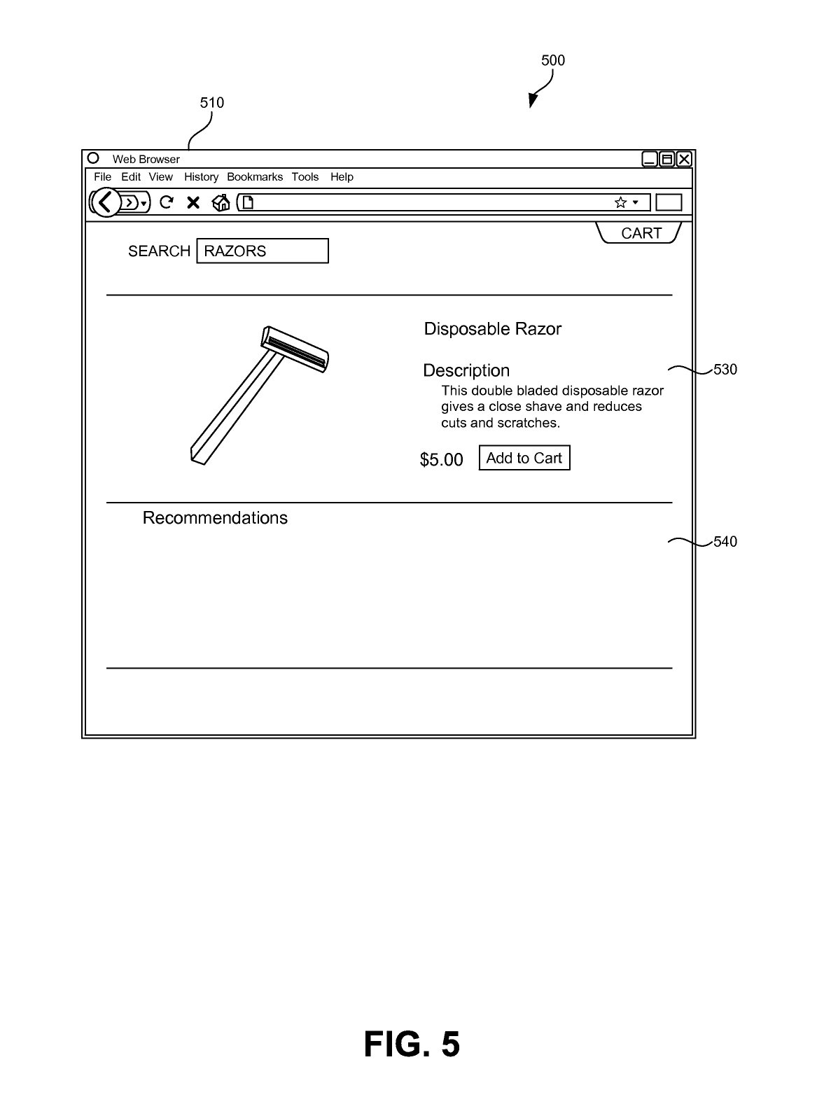

FIG. 5 illustrates an interface 500 for displaying a selected item according to one embodiment. Browser window 510 includes a selected item 530, which is disposable razor. Browser window 510 may be similar to browser window 310 illustrated in FIG. 3. A section of browser window 510 may be dedicated to displaying recommended items 540. Note that in FIG. 5, the display for recommended items 540 is blank. This may correspond to one or more of the following situations: no recommended items are available, the customer has never purchased items of this type before, the item is not included in the set of items, the item is not associated with a customer type, and/or the like. In one embodiment, the customer may choose not to have recommended items displayed, in which case recommended items 540 may also be blank. Also note that if the disposable razor corresponding to the selected item 530 also belongs to a set of items, such as a package of disposable razors, the set of items may be displayed as one more of the recommended items 540.

Because the disposable razor may be expected to be physically degraded after a period of expected use, the disposable razor will need to be replaced approximately at a calculated expiration of the expected period of use. For example, a single disposable razor may have an expected period of use of one week. Therefore, it may be expected that approximately one week after it is purchased, the disposable razor would need to be replaced. It may be beneficial for a customer to receive an indication that the disposable razor may be need to be replaced around the calculated expiration date to avoid running out of the item.

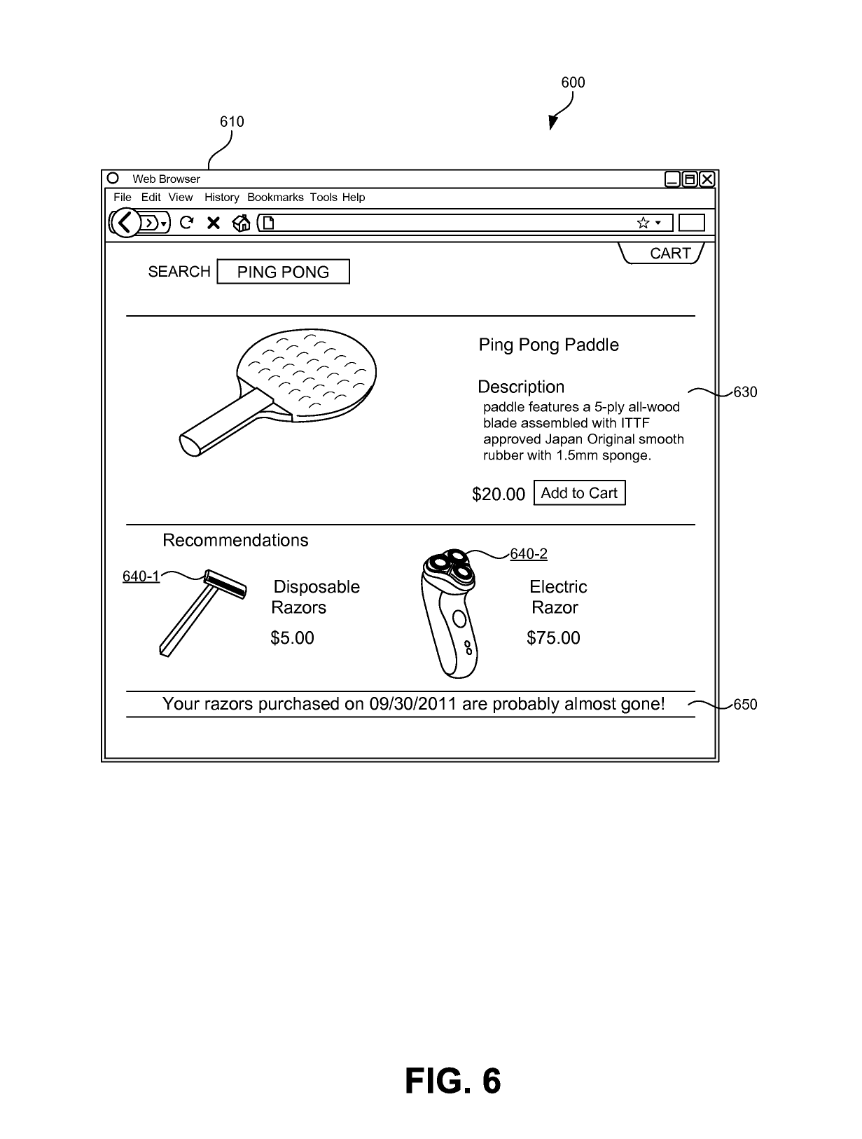

FIG. 6 illustrates an interface 600 for recommending additional items based on the expiration of an expected period of use. For example, if a customer purchased one or more disposable razors during a previous transaction, it may be a beneficial to suggest either additional disposable razors 640-1, or a comparable product, such as an electric razor 640-2. Note that during the current search in FIG. 6, the customer is searching for “ping-pong”, not “razors” Therefore, the selected item 630 is a ping-pong paddle, and need not be related functionally or otherwise to the recommended items 640. The recommendation of the recommended items 640 may be based upon a prior transaction involving an expected period of use, instead of on the current selected item. Furthermore, Web browser 610 may include an indication 650 describing why recommended items 640 have been recommended. For example, indication 650 may display a message such as “your razors are probably almost gone,” or “your product has expired,” or “your product may no longer be usable.”

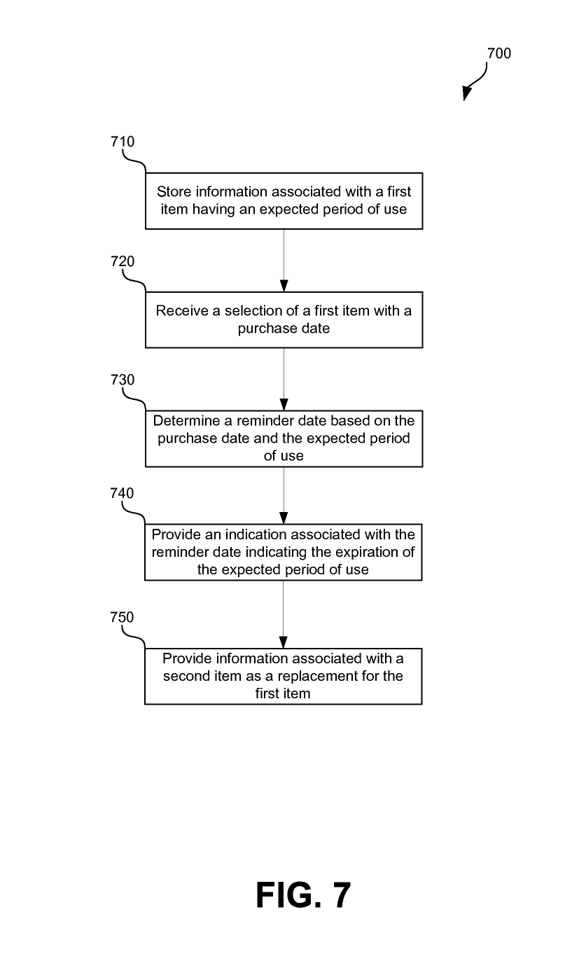

FIG. 7 illustrates a method 700 for generating item recommendations according to an expected period of use, according to one embodiment. At step 710, information may be stored that is associated with a first item. The first item may have expected period of use. The period of use may comprise a product expiration date, a license expiration date, a physical expiration date, and/or any other measure of item lifetime. Information may be stored in the item information storage module 150.

At step 720, a selection of the first item may be received wherein the first item has a purchase date. In one embodiment, the purchase date may be the date on which the item was selected by a customer for purchase. For online purchase, this may be the date on which the item was placed into an electronic shopping cart. In another embodiment, the purchase date may be the date on which the item was shipped from a retailer to the customer. In yet another embodiment, the purchase date may be the date on which the item was received by the customer. For example, the purchase date of a perishable item may be the date on which the item was selected, whereas the purchase date of a consumable item may be the date the customer received the item. In one embodiment, it may be possible for the customer to enter a date on which the item will begin to be used. In this case, the customer may be allowed to provide the most accurate information as to when the period of actual expected use may begin.

At step 730 a reminder date may be determined based on the purchase date and the expected period of use of the product. In one embodiment, the reminder date may be an expiration date of a perishable item, and the reminder date may be calculated by determining the difference between the purchase date and the expiration date. In another embodiment, the reminder date may be based on an expected period of use that is then multiplied by the number of items purchased. For example, if a package of five disposable razors were purchased, the reminder date may be calculated by multiplying the expected period of use for each razor by the total number of razors in each package (five), and adding that period of time to the purchase date. The scheduling module 160 may record the reminder date to be later provided to the customer at an appropriate time.

The reminder date may be calculated at least part based on the purchase date and the expected period of use. In addition to the purchase date and the expected period of use, the reminder date may also be calculated based on previous purchases. In one embodiment, it may be determined that multiple purchases of a disposable item could affect the reminder date. For example, if a disposable razor is purchased every day for one week, the reminder date associated with the final razor purchased may be based on the purchase date, the expected period of use, and the expected periods of use of the previously purchased razor blades. Other embodiments may use additional information to calculate a reminder date.

At step 740, an indication associated with reminder date may be provided indicating the expiration of the expected period of use. The time at which this indication is provided need not be on the reminder date. In one embodiment, the indication is provided on the first date after the reminder date when the customer accesses and/or uses a computer system that was originally used to purchase the first item. For example, the computer system may be used to operate a retailer's website. The first time a customer accesses the retailer's website after the reminder date, the website may provide an indication that the previously purchased item may have expired and/or need to be replaced. In another embodiment, an indication is provided on the reminder date and sent to the customer via an electronic messaging system, such as e-mail, text messaging, voicemail, Twitter®, Facebook®, traditional mail, and/or the like. In another embodiment, an indication may be provided prior to the reminder date such that the customer may have time to purchase replacement items before the end of the first item's expected period of use. For example, an e-mail message may be sent to the customer one week prior to the reminder date indicating that the customer's previously purchased razor blades may be physically degraded to a point that they may no longer perform above a threshold level of performance in the near future.

Step 750, information may be provided that is associated with a second item to be used as a replacement for the first item. The second item may be substantially similar to the first item. “Substantially similar”, as used herein, means that the second item may act as a replacement for the first item. In one embodiment, the second item performs at least the same functions as the first item. In another embodiment, the second item is of the same type of item is the first item, possibly same brand and model. In another embodiment, the second may be a subsequent version of the first item. For example, the second item may be an upgraded version of the first item, particularly if the original version of the first item is no longer available. In yet another embodiment the second item may be a set of items that includes the first item. For example, if the first item was a single disposable razor blade, the second item may be a package of disposable razor blades.

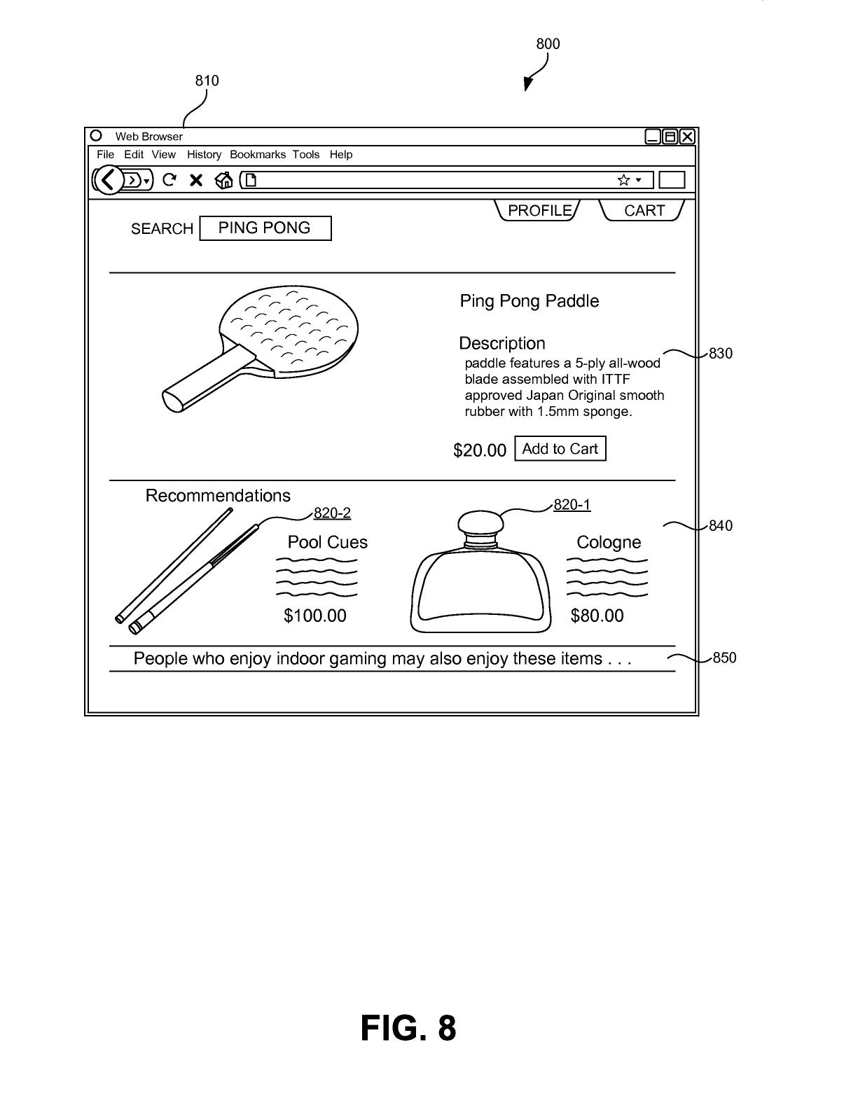

In addition to recommending items based on membership in a set and the expiration of an expected period of use, recommendations may be made based on a customer type. FIG. 8 illustrates an interface 800 for providing item recommendations based on a customer type. Web browser 810 may be configured to display a selected item 830, which in this case corresponds to a ping-pong paddle. Based at least in part on the selection of the selected item 830, it may be determined that the customer is of a particular customer type. Customer type information may be stored and evaluated by the customer type module 140 in FIG. 1. Based on the customer type, recommended items 840 may be recommended to the customer.

In one embodiment a set of items may be associated with a customer type. When a customer selects one or more of the items in the set of items, the customer may be assigned that particular customer type. In response, additional items in the set of items may be recommended to the customer. For example, in FIG. 8 a ping-pong paddle may belong to a set of items assigned to a customer type, along with pool cues and cologne. When a customer selects the ping-pong paddle as a selected item in 830, the pool cues 820-2 and the Cologne 820-1 may be recommended items 840 provided to the customer. An indication 850 may be provided that explains or otherwise indicates the reason that the recommended items 840 may have been provided.

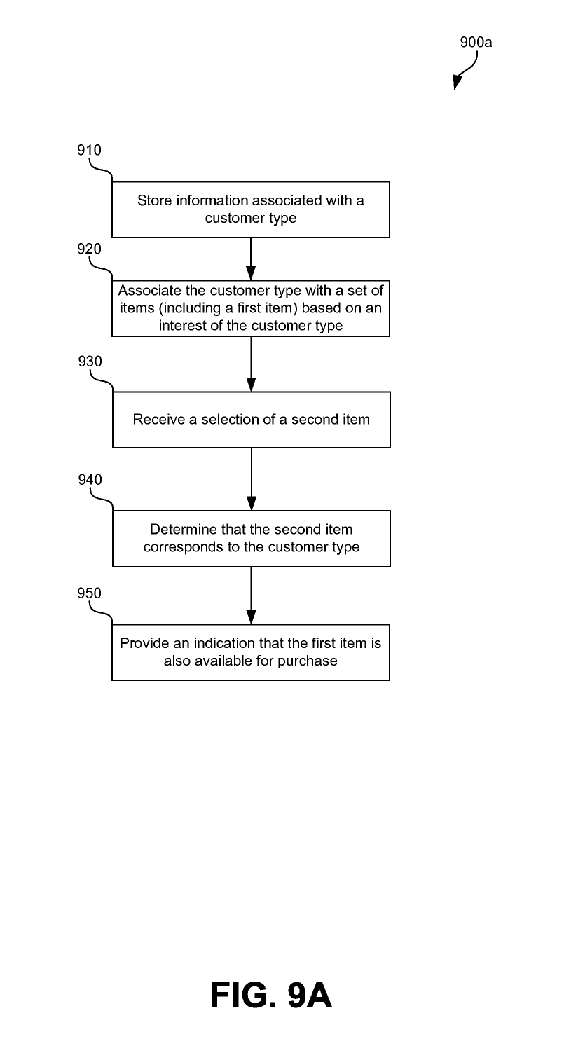

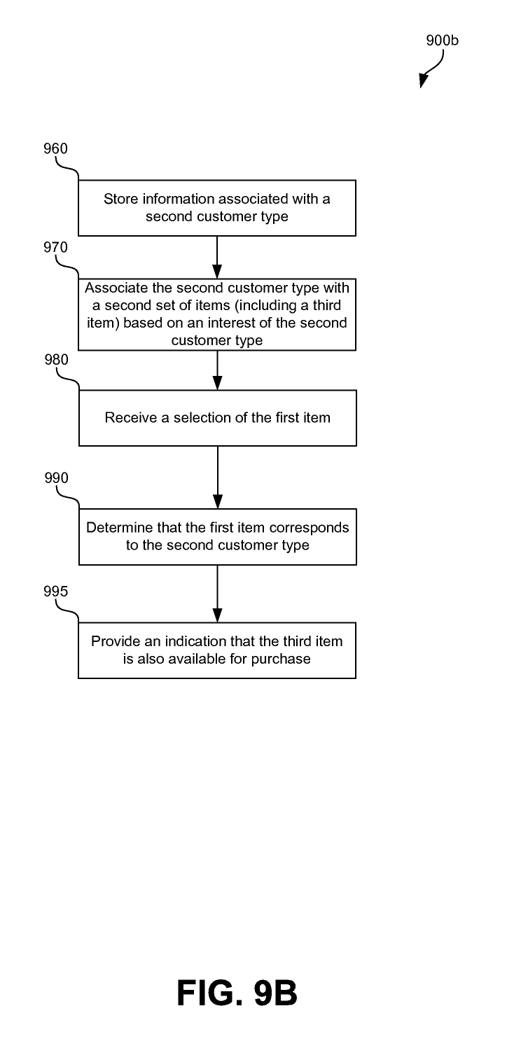

FIG. 9A illustrates a method 900a for providing item recommendations based on a customer type. At step 910, information may be stored that is associated with a customer type. At step 920, the information associated with a customer type may include a set of items. The set of items may be associated with a customer type, or the customer type may be formed based on the set of items. In one embodiment a set of items may be formed based on one or more interests of the customer type. For example, one customer type may be associated with males who enjoy indoor gaming. A set of items for this customer type may include ping-pong paddles, pool cues, and cologne, along with other items. In one embodiment, a set of items may all be functionally related to one another. For example, each of the items in a set of items may be equipment used an indoor gaming. Furthermore, one of these items in the set of items may be designated as a “first item”.

At step 930, the selection of a second item may be received. This selection may be made by a customer in the course of searching for items to purchase. Such a selection may indicate either an intent to purchase the second item, or a desire to see more information associated with the second item. At step 948, it may be determined that the second item corresponds to the customer type. This determination may be made by determining that the second item belongs to the set of items associated with the customer type. In one embodiment, determining that the second item corresponds to a customer type may use additional information, such as information defining interests of the customer. For example, a customer may create a user profile, and the customer may store interests and personal information and customer profile. Customer profile information may then be used in conjunction with the selected item to determine that the selected item corresponds to the customer type.

At step 950, an indication that the first item may also be purchased may be provided to the customer in response to the determination that the selected item corresponds to the customer type. As with the other methods disclosed herein, this indication may be provided by various methods, including display on a screen, e-mail, text messaging, voice messaging, direct mail, and/or the like.

FIG. 9B illustrates a method 900b of generating additional item recommendations based on the selection of the first item in the set of items, according to one embodiment. In method 900b, a customer may have already selected the second item, been associated with a customer type, and provided an indication that the first item may be purchased. At step 960, information associated with a second customer type may be stored. At step 970, the second customer type may be associated with a second set of items. Like the first set of items, the second set of items may be related to an interest of the second customer type. The second set of items and also include a third item.

At step 980, a selection of the first item may be received. Note that the first item belongs to the first set of items associated with the first customer type. At step 990, it may be determined that the first item also corresponds to the second customer type. In one embodiment, this determination may be made by determining that the first item is a member of both the first set of items and the second set of items. In other words, the customer may first select the second item, then be recommended the first item because the first item corresponds to the same customer type as the second item. If the customer then selects the first item (which belongs to both customer types) that customer may be recommended additional items corresponding to the second customer type as well. At step 995, an indication may be provided that the third item is also available for purchase.

Each of the steps in method 900a and 900b, along with the other methods disclosed hereinabove, may be performed by a computer system, such as the computer system 1000 of FIG. 10. Each of the steps may be performed automatically by the computer system, and/or may be performed using inputs and outputs to and from a user. Additionally, instructions for performing these methods may be stored in a memory that is configured to cause the processor in the computer system to execute the various steps of the methods. For example, determinations may be made by one or more processors, information may be stored in one or more memories, inputs may be received by one or more input devices, and indications and outputs may be provided by one or more output devices such as those described below and illustrated in FIG. 10.

FIG. 10 illustrates an embodiment of a computer system. A computer system as illustrated in FIG. 10 may be incorporated as part of the previously described computerized devices. For example, computer system 1000 can perform the methods and evaluate the equations discussed herein. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

The computer system 1000 is shown comprising hardware elements that can be electrically coupled via a bus 1005 (or may otherwise be in communication, as appropriate). The hardware elements may include one or more processors 1010, including without limitation one or more general-purpose processors and/or one or more special-purpose processors (such as digital signal processing chips, graphics acceleration processors, and/or the like); one or more input devices 1015, which can include without limitation a mouse, a keyboard, and/or the like; and one or more output devices 1020, which can include without limitation a display device, a printer, and/or the like.

The computer system 1000 may further include (and/or be in communication with) one or more non-transitory storage devices 1025, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computer system 1000 might also include a communications subsystem 1030, which can include without limitation a modem, a network card (wireless or wired), an infrared communication device, a wireless communication device and/or chipset (such as a Bluetooth device, an 802.11 device, a WiFi device, a WiMax device, cellular communication facilities, etc.), and/or the like. The communications subsystem 1030 may permit data to be exchanged with a network (such as the network described below, to name one example), other computer systems, and/or any other devices described herein. In many embodiments, the computer system 1000 will further comprise a working memory 1035, which can include a RAM or ROM device, as described above. For instance, the various methods described herein may be performed over a network to allow a user to execute processing remotely. As such, a user may interact with a remote computer, communicating with a server to execute the various methods remote from the user.

The computer system 1000 also can comprise software elements, shown as being currently located within the working memory 1035, including an operating system 1040, device drivers, executable libraries, and/or other code, such as one or more application programs 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1025 described above. In some cases, the storage medium might be incorporated within a computer system, such as the computer system 1000. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1000) to perform methods in accordance with various embodiments of the invention. According to a set of embodiments, some or all of the procedures of such methods are performed by the computer system 1000 in response to one or more processors 1010 executing one or more sequences of one or more instructions (which might be incorporated into the operating system 1040 and/or other code, such as an application program 1045) contained in the working memory 1035. Such instructions may be read into the working memory 1035 from another computer-readable medium, such as one or more of the storage device(s) 1025. Merely by way of example, execution of the sequences of instructions contained in the working memory 1035 might cause the processor(s) 1010 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1000, various computer-readable media might be involved in providing instructions/code to processor(s) 1010 for execution and/or might be used to store and/or carry such instructions/code (e.g., as signals). In many implementations, a computer-readable medium is a physical and/or tangible storage medium. Such a medium may take the form of a non-volatile media or volatile media. Non-volatile media include, for example, optical and/or magnetic disks, such as the storage device(s) 1025. Volatile media include, without limitation, dynamic memory, such as the working memory 1035.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000. These signals, which might be in the form of electromagnetic signals, acoustic signals, optical signals and/or the like, are all examples of carrier waves on which instructions can be encoded, in accordance with various embodiments of the invention.

The communications subsystem 1030 (and/or components thereof) generally will receive the signals, and the bus 1005 then might carry the signals (and/or the data, instructions, etc. carried by the signals) to the working memory 1035, from which the processor(s) 1005 retrieves and executes the instructions. The instructions received by the working memory 1035 may optionally be stored on a storage device 1025 either before or after execution by the processor(s) 1010.

The methods, systems, and devices discussed above are examples. Various configurations may omit, substitute, or add various procedures or components as appropriate. For instance, in alternative configurations, the methods may be performed in an order different from that described, and/or various steps may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the flow diagram or block diagram. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for generating item recommendations, the method comprising:
storing, by a computer system, information associated with a set of items, wherein:
the set of items includes a first item;
at least the first item in the set of items is available for sale individually;
each item in the set of items that is for sale individually is associated with an item price; and
the set of items may be purchased as a single-purchase item, wherein:
the set of items has a set price; and
the set of items was packaged as a set by a manufacturer of the set of items;
receiving, by the computer system, a selection;
determining, by the computer system, that the selection corresponds to the first item in the set of items;
determining, by the computer system, that the selection indicates an interest in the first item;
providing, by the computer system, an indication the that first item is included in the set of items; and
providing, by the computer system, an indication that the set of items may be purchased as a single-purchase item at the set price.

2. The method for generating the item recommendations of claim 1, further comprising providing, by the computer system, an indication of the item prices associated with each item in the set of items that is available for sale individually.

3. The method for generating the item recommendations of claim 2, further comprising providing, by the computer system, a comparison between the set price and a sum of the item prices for each item in the set of items that is available for sale individually.

4. The method for generating the item recommendations of claim 1, further comprising:
storing, by the computer system, second information associated with a second set of items, wherein:
the second set of items includes the first item;
the second set of items includes more items than the set of items; and
the second set of items may be purchased as a single-purchase item, wherein:
the second set of items has a second set price; and
providing, by the computer system, in response to the selection, an indication that the first item is also included in the second set of items; and
providing, by the computer system, an indication that the second set of items may be purchased as a single-purchase item at the set price.

5. The method for generating the item recommendations of claim 1, further comprising:
receiving, by the computer system a second selection; and
determining, by the computer system:
that the second selection corresponds to the set of items; and
that the second selection indicates an interest in purchasing the set of items.

6. The method for generating the item recommendations of claim 5, further comprising:
storing, by the computer system, in an electronic shopping cart, information associated with the selection which corresponds to the first item in the set of items;
determining that the first item should be removed from the electronic shopping cart based on the second selection;
removing, by the computer system, and in response to the second selection, the information associated with the selection from the electronic shopping cart; and
storing, by the computer system, in the electronic shopping cart; and in response to the second selection, information associated with the second selection which corresponds to the set of items.

7. The method for generating the item recommendations of claim 1, wherein each item in the set of items is functionally related to at least one other item in the set of items.

8. The method for generating the item recommendations of claim 7, wherein the way in which each item is functionally related to at least one other item in the set of items is that each item in the set of items is for a recreational activity.

9. The method for generating the item recommendations of claim 1, further comprising providing, by the computer system, an indication of a difference between the set price and a sum of the item prices for each item in the set of items that is available for sale individually.

10. A computer program product residing on a non-transitory processor-readable medium for generating item recommendations, the computer program product comprising computer-readable instructions configured to cause a computer to:
store information associated with a first item, wherein:
the first item is available for sale;
the first item has an expected period of use; and
the first item is expected to be replaced approximately at an expiration of the expected period of use;
receive a selection, wherein:
the selection indicates an interest in purchasing the first item; and
the selection is made on a purchase date;
determine a reminder date that is based at least in part on the purchase date and the expected period of use;
provide an indication that is associated with the reminder date that indicates the expiration of the expected period of use for the first item; and
provide information associated with a second item that is substantially similar to the first item as a replacement for the first item.

11. The computer program product for generating the item recommendations of claim 10, wherein after the expiration of the expected period of use, the first item is expected to physically degrade.

12. The computer program product for generating the item recommendations of claim 10, wherein the second item is the same type of item as the first item.

13. The computer program product for generating the item recommendations of claim 10, wherein the second item is an alternate item that performs the same function as the first item.

14. The computer program product for generating the item recommendations of claim 10, wherein the indication that is associated with the reminder date is provided prior to the reminder date.

15. The computer program product for the generating item recommendations of claim 10, wherein the indication is provided on the reminder date.

16. The computer program product for generating the item recommendations of claim 10, wherein providing an indication that is associated with the reminder date occurs in response to receiving an input from a user who purchased the first item, and on a date subsequent to the reminder date.

17. A system for generating item recommendations, the system comprising:
a computer system, comprising:
a processor; and
a memory communicatively coupled with and readable by the processor and having stored therein processor-readable instructions which, when executed by the processor, cause the processor to:
store information associated with a customer type, wherein;
the information associated with the customer type is comprised of a set of items;
each item in the set of items is associated with an interest of the customer type; and
the set of items includes a first item;
receive a selection, wherein the selection indicates an interest in a second item;
determine that the selection corresponds to the customer type at least in part by determining that the second item belongs to the set of items; and
provide, in response to the determination that the selection corresponds to the customer type, an indication that the first item may be purchased.

18. The system for generating the item recommendations of claim 17, wherein determining that the selection corresponds to the customer type is determined at least in part by information defining interests of a customer.

19. The system for generating the item recommendations of claim 17, wherein the second item is functionally related to the first item.

20. The system for generating the item recommendations of claim 17, wherein the processor-readable instructions are further configured to cause the processor to:
store second information associated with a second customer type, wherein;
the second information associated with the second customer type is comprised of a second set of items;
each item in the second set of items is associated with an interest of the second customer type; and
the second set of items includes a third item;
receive a second selection, wherein the second selection indicates an interest in the first item;
determine that the second selection corresponds to the second customer type at least in part by determining that the first item belongs to the second set of items; and
provide, in response to the determination that the second selection corresponds to the second customer type, an indication that the third item may be purchased.
